(19) United States
(12) Patent Application Publication
(10) Pub. No.: US 2022/0266605 A1
(43) Pub. Date: Aug. 25, 2022

(54) PRINTER FOR PRINTING ON HISTOLOGY LABORATORY CONSUMABLES

(71) Applicant: LEICA BIOSYSTEMS NUSSLOCH GMBH, Nussloch (DE)

(72) Inventor: Karl-Heinz WESTERHOFF, Eppingen (DE)

(21) Appl. No.: 17/627,348

(22) PCT Filed: Jul. 6, 2020
(86) PCT No.: PCT/EP2020/068975

§ 371 Date: Jan. 14, 2022

(30) Foreign Application Priority Data
Jul. 18, 2019 (DE) 10 2019 119 507.1

(51) Int. Cl. B41J 3/01; G01N 35/00

(52) U.S. Cl. CPC B41J 3/01; G01N 35/00732; G01N 2035/00861; G01N 2035/00811

(57) ABSTRACT

A printer for printing on histology-laboratory consumable articles (16) includes a control apparatus (8), which is configured to receive analog or digital image signals of a target impression image pattern, and an optical reading apparatus (13). The optical reading apparatus (13) reads an impression (18) printed on a histology-laboratory consumable article (16) by the printing device (4), generates analog or digital impression image signals relating to the impression (18) that has been read, and transfers the impression image signals to the control apparatus (8). The control apparatus (8) evaluates the impression image signals received from the optical reading apparatus (13) by comparing them with the analog or digital image signals of the target impression image pattern and determines at least one quality parameter relating to the impression (18).

### CROSS-REFERENCE TO RELATED APPLICATIONS

The present application is the U.S. national phase of International Application No. PCT/EP2020/068975 filed Jul. 6, 2020, which claims priority to German Application No. 10 2019 119 507.1 filed Jul. 18, 2019, the entire disclosures of which are incorporated herein by reference.

### FIELD OF THE DISCLOSURE

The invention relates to a printer for printing on histology-laboratory consumable articles having a control apparatus which is configured to receive analog or digital image signals of a target impression image pattern, and having an optical reading apparatus.

### BACKGROUND OF THE DISCLOSURE

Histological samples taken from a patient pass through a multiplicity of treatment steps in various treatment stations in a histological laboratory before they can be examined, for example with a microscope.

The purpose of the treatment of a histological sample is usually to put it in a state which allows slicing into thin layers with a microtome. This treatment is carried out at a plurality of processing stations. Sliceability may, for example, be made possible by introducing (infiltrating) a mechanically stabilizing medium into the tissue in a plurality of successive processing steps. For this purpose, the samples usually pass through a multiplicity of processing stations. For example, processing stations in the form of cutting stations, fixing stations, dehydration stations, cleaning stations, infiltration stations, embedding stations or microtomes (slicing stations) in a wide variety of embodiments are known. The fixing, dehydration, cleaning and infiltration may, for example, be carried out successively in a retort of a single item of equipment.

In a cutting station, the tissue, taken for example from a patient, is sliced into individual samples. The samples are usually placed in cassettes and transported to a fixing station. Fixing of the samples is necessary because the oxygen supply of the cells is stopped after the tissue is taken from the patient, which leads to cell death. Swelling of the cells may initially be observed, and protein denaturation as well as autolysis with subsequent bacterial digestion furthermore take place. In order to counteract this damage, the samples that have been taken are fixed in a fixing station with a fixative, for example formaldehyde.

After the treatment in the fixing station, dehydration of the samples is carried out in a dehydration station. Dehydration of the samples is necessary in order to permit the subsequent process of infiltration and embedding. Since the fixative, in particular formaldehyde, is usually an aqueous medium, while the infiltration or embedding agent to be used, in particular paraffin, is usually a medium that is immiscible with water, dehydration of the samples must be carried out before the further treatment of the samples in the dehydration station. The dehydration of the samples is carried out with the aid of a dehydrating agent, for example ethanol.

Before the samples are transferred to the infiltration station, they are furthermore cleaned. Cleaning is necessary since the alcohol in the tissue of the sample is immiscible with paraffin. The alcohol must therefore be removed from the tissue before the infiltration and replaced with a reagent, such as xylene, which is miscible with paraffin. After treatment of the sample in the cleaning station, it is brought to an infiltration station. In the infiltration station, an infiltration agent, which usually corresponds to the embedding agent subsequently used, is introduced into cavities of the sample until they are saturated. By the addition of the infiltration agent, the samples can be mechanically stabilized.

After the treatment of the sample in the infiltration station, it is processed in the embedding station. In the embedding station, embedding of the histological sample in an embedding agent, for example paraffin or wax, is carried out. In practice, the term “embedding” is used twofold. On the one hand, the term is used as a synonym for “infiltration”, which is carried out in the aforementioned infiltration station, and on the other hand the term is also used for the “blocking” which is carried out in the embedding station.

For the embedding, the samples are removed from the cassette and placed together with the cassette in so-called molds, which are filled with the embedding agent. Cooling is subsequently carried out so that the embedding agent can set. For the cooling, the molds are usually placed on a cooling plate of the embedding station. As a result, an embedding block in which the sample is fixed in position on the cassette is obtained. After setting of the embedding agent, the cassette may be clamped in a microtome and the sample may be sliced into individual thin sample sections with the microtome, which can be placed on a slide and in a next step dyed and examined with a microscope.

In the process sequence, it is necessary in particular to ensure that the samples, or the sample sections, can at all times be assigned to the patient. To this end, special printers with which the cassettes in which the samples are intended to be fitted, and/or the slides on which the sample sections are placed, and/or the histology-laboratory consumable article labels, in particular adhesive labels, can be printed on in particular with patient-relevant data are used in histological laboratories. In this case, it is very important for the impression to be readable sufficiently accurately and sufficiently durably.

EP 1 245 395 A2 describes a method and an apparatus for printing on plastic cassettes fir histological preparations and/or slides for microscopic thin sections. The apparatus comprises a computer device for controlling the printing device. The printing device contains an inkjet printer for printing on the cassettes and/or the slides. The ink is predried by means of a warm-air dryer and fully dried by means of a flash device.

A system for identifying a tag on a tissue cassette in an arrangement of a plurality of tissue cassettes is known from US 2019/0105021 A1. The system comprises a sensor which automatically detects a tag on an individual tissue cassette or an image of the plurality of tissue cassettes in the arrangement. The system may contain a processor which can compare a tag with a tissue processing log.

US 2019/0324048 A1 discloses a slide printer which prints two barcodes onto a slide. A first barcode relates to a control tissue sample while a second barcode relates to a patient tissue sample. The slide printer contains a barcode reader which can read the first barcode printed previously by the slide printer itself.

### SUMMARY OF THE DISCLOSURE

The object of the present invention is to provide a printer for printing on histology-laboratory consumable articles, which increases the security of the process sequence during the processing of histological samples.

The object is achieved by a printer for printing on histology-laboratory consumable articles, which is characterized in that the optical reading apparatus reads an impression printed on a histology-laboratory consumable article by the printing device, generates analog or digital impression image signals relating to the impression that has been read, and transfers the impression image signals to the control apparatus, which evaluates the impression image signals received from the optical reading apparatus by comparing them with the analog or digital image signals of the target impression image pattern and determines at least one quality parameter relating to the impression.

The invention has the very particular advantage that assignability of the histology-laboratory consumable article to a particular sample, or a particular patient, is ensured in that a check is made as to whether the respective impression has been carried out properly. This advantageously ensures that the reading of the impression by machine and/or by a person during the subsequent process steps in the processing of the sample can always be carried out reliably.

The invention makes it possible to recognize whether the impression is carried out with a quality sufficient for a subsequent reading by a person and/or by a machine. If, for example, it is found that the impression is out of focus and/or blurred, a warning may for example be output. As an alternative or in addition, it is for example also possible to reject a histology-laboratory consumable article that has been printed on defectively, to repeat the printing of the desired impression on another histology-laboratory consumable article, and thus to replace the histology-laboratory consumable article having the defective impression with another histology-laboratory consumable article having an impression as intended.

The impression which the printer applies may be monochromatic or, as an alternative, also polychromatic.

The control apparatus evaluates the impression image signals received from the optical reading apparatus, which at least involves comparing the received impression image signals with the analog or digital image signals of the associated target impression image pattern. In particular, the control apparatus may advantageously compare the impression image signals received from the optical reading apparatus with the image signals of the target impression image pattern by image analysis and/or by pattern recognition.

The printer may receive the analog or digital image signals of the target impression image pattern, which may contain in particular patient data in clear text or encoded form, for example from a superordinate computer to which the printer is connected directly or via a network.

Preferably, the control apparatus controls the printing device of the printer in such a way that an impression that is as close as possible to the respective target impression image pattern is printed onto the respective histology-laboratory consumable article.

The control apparatus determines at least one quality parameter relating to the impression. The quality parameter may in particular relate to the sharpness of the impression and/or the contrast of the impression and/or the printing resolution of the impression and/or the accuracy of the color or colors of the impression and/or the constancy of the color or colors of the impression and/or the color gradient of the impression and or the location of the impression on the histology-laboratory consumable article. Quality parameters may in particular also relate to the presence of the impression on the histology-laboratory consumable article. If it is found that an impression has not been carried out at all, for example a warning may be output and/or a check, in particular an automatic check, of the printing device, in particular of the ink or toner filling level, may be carried out.

The control apparatus evaluates the impression image signals received from the optical reading apparatus by comparing them with the analog or digital image signals of the target impression image pattern. As a function of the evaluation result, the control apparatus may establish at least one processing step for the further processing of the histology-laboratory consumable article inside the printer.

The establishment of at least one processing step is not necessarily final. For example, the control apparatus may initially establish as a processing step that an input by the user is required. After receiving the input and depending on the decision by the user, the control apparatus may then establish further processing steps.

The request for an input by a user may in particular be carried out when it has been established that an impression has not been carried out, or has not been carried out correctly. In this case, the user may for example inspect the histology-laboratory consumable article and either cause release or a printing repetition of the target impression image pattern on another histology-laboratory consumable article.

The printer may comprise a button or a keypad and/or another input apparatus, by means of which the user can make an input. As an alternative or in addition, it is also possible for the input to be entered via a computer, to which the printer is connected directly or via a network. The control apparatus evaluates the input and, as a function of the content of the input, may then delete an already established processing step and/or establish at least one further processing step for the further processing of the histology-laboratory consumable article.

In one very particularly advantageous embodiment, the control apparatus may stop the further processing of a histology-laboratory consumable article, in relation to which an input is expected, until the input arrives, and instead begin or continue the processing of at least one other histology-laboratory consumable article. This embodiment has the very particular advantage that the time available for printing on a multiplicity of histology-laboratory consumable articles is constantly utilized. In particular, a histology-laboratory consumable article, in relation to which an input is expected, may advantageously temporarily be excluded and transferred to a standby position. As soon as the required input has taken place, the histology-laboratory consumable article is retrieved from the standby position and then, particularly as a function of the input made, either processed further or discarded, preferably in favor of repeating the impression on a new histology-laboratory consumable article.

It is possible for one of the processing steps to involve outputting a message to a user. For example, the printer according to the invention may be adapted in such a way that the control apparatus outputs the message that everything is in order when the control apparatus has established that a high-quality impression has been applied. Similarly, it is also possible for a warning to be output when the control apparatus has recognized that a sufficiently high-quality impression has not been carried out.

In one very particularly advantageous embodiment, the control apparatus establishes at least one printing parameter for the repetition of the printing of the target impression image pattern on another histology-laboratory consumable article as a function of the image signals of the impression that has been read and/or as a function of a quality parameter determined relating to the impression. In this embodiment, the new impression on another histology-laboratory consumable article is advantageously carried out with at least one modified printing parameter in order to avoid another defective impression. The control apparatus preferably changes the printing parameter (or a plurality of printing parameters) specifically in respect of the error established or the error type established in the defective impression previously carried out. The printing parameter may for example relate to the ink, in particular the type of ink, or the toner, in particular the type of toner, or a drying temperature or a drying duration or a font size to be used or a font type to be used. For example, it is possible for the control apparatus to select a different ink from a different ink reservoir of the printer and/or a different drying duration for a new impression.

In one particular embodiment, the control apparatus respectively saves the received impression image signals in a memory device. In particular, the control apparatus may advantageously save the received impression image signals respectively together with the image signals of the associated target impression image pattern. In this way, the impression may be compared with the target impression image pattern at a later time, in particular by machine or by a user.

The printer may comprise a transport apparatus which transports the histology-laboratory consumable articles. In particular, the printer may comprise a compartment, in particular in the form of a material supply, for a multiplicity of histology-laboratory consumable articles to be printed on, from which the transport apparatus in particular individually takes the histology-laboratory consumable articles to be printed on and transports them further to the printing device.

In one particularly advantageous embodiment, the transport apparatus transports the histology-laboratory consumable article printed on by the printing device further to a removal device from which the histology-laboratory consumable article that has been printed on can be removed, in particular together with further histology-laboratory consumable articles that have been printed on. In this embodiment, the optical reading apparatus may particularly advantageously read the impression respectively during the transport of the histology-laboratory consumable article that has been printed on. This has the particular advantage that the reading of the impression may be carried out in dead time so that the overall process sequence inside the printer is not slowed down.

The printing device may in particular be configured to apply an impression configured as an image or as a barcode or as a QR code or as a logo or as text onto the histology-laboratory consumable article. Similarly, the optical reading apparatus is preferably configured and arranged to read an impression configured as an image or as a barcode or as a QR code or as a logo or as text from a histology-laboratory consumable article.

In one very particularly advantageous embodiment, the control apparatus keeps a log. In particular, whether it has been possible to evaluate an image pattern that has been read and/or whether an impression that has been read is error-free may advantageously be logged for each individual histology-laboratory consumable article introduced. The log may in particular contain the image data of the impression that has been read and/or the printing parameters relating to the impression carried out. Furthermore, the log may contain information about the instant of the processing of the respective histology-laboratory consumable article and/or about an assigned patient and/or the batch number of the printing medium used and/or the batch number of the histology-laboratory consumable article used.

Preferably, the control apparatus saves log data continuously in a memory and/or outputs log data via an interface. As an alternative or in addition, it is also possible for the control apparatus to display, in particular continuously display, the log data on an output apparatus, for example a display of the printer.

In one very particularly advantageous embodiment, the log data are transferred to a superordinate computer and saved and/or processed further there.

In particular—and according to an independent inventive concept—the superordinate computer may advantageously receive further log data of other printers and/or other laboratory equipment and save and/or further process them, in particular together with the log data of the printer. Very generally and according to the independent inventive concept, a histology laboratory system which contains a superordinate computer that receives, saves and/or further processes the log data of a printer according to the invention and/or further log data of other laboratory equipment is particularly advantageous.

Preferably, the log data and the further log data, which relate to the same sample, are saved and/or processed further by the superordinate computer while being assigned to one another and together. In particular, this makes it possible for a superordinate log, which contains the log data transferred from the printer and the further log data of other printers and/or other laboratory equipment, to be compiled by the superordinate computer in particular in a sample-specific manner. The superordinate log may preferably contain data relating to all process steps during the processing of a sample in a histological laboratory. To this extent, the superordinate log may in particular contain log data and further log data, which contain the processing of a sample from the cutting station to the diagnosis by means of a microscope. It is, however, also possible for the superordinate log to contain log data and further log data of a subsection of such a processing sequence of a sample.

In one variant, logging is exclusively carried out only in the cases recognized as problematic, in particular when the quality of the impression is insufficient.

In particular, one of the processing steps may involve saving the image signals of the impression that has been read and/or saving information determined by the control apparatus about the histology-laboratory consumable article. This may in particular be carried out in such a way that the corresponding data are stored in the log already mentioned above.

The histology-laboratory consumable article to be printed on by means of the printer according to the invention may in particular be a cassette in which at least one histological sample is fitted or is intended to be fitted, or a slide on which a sample section is placed or is intended to be placed, or a label, and in particular an adhesive label, of a histology-laboratory consumable article. Preferably, the printer is configured and intended to provide histology-laboratory consumable articles of at least one of the aforementioned types of histology-laboratory consumable articles with an impression. To this extent, the printer may especially be configured as a cassette printer and/or as a slide printer and/or as a label printer.

The printer according to the invention may in particular be configured as an inkjet printer or as a laser printer.

According to an independent inventive concept, a printer having a printing device for printing on histology-laboratory consumable articles, characterized by an optical reading apparatus which reads an impression printed on a histology-laboratory consumable article by the printing device, generates analog or digital impression image signals relating to the impression that has been read, and transfers the impression image signals to a control apparatus of the printer, is particularly advantageous. The printer may have one or more of the additional features stated above and/or mentioned in the claims.

### BRIEF DESCRIPTION OF THE DRAWING VIEWS

The subject-matter of the invention is represented by way of example and schematically in the drawing and will be described below with the aid of the figures, elements which are the same or have the same effect also usually being provided with the same references in the various exemplary embodiments.

FIG. 1 shows a first exemplary embodiment of a printer according to the invention,

FIG. 2 shows a second exemplary embodiment of a printer according to the invention,

FIG. 3 shows a detail of a third exemplary embodiment of a printer according to the invention, and

FIG. 4 shows a detail of a fourth exemplary embodiment of a printer according to the invention.

### DETAILED DESCRIPTION

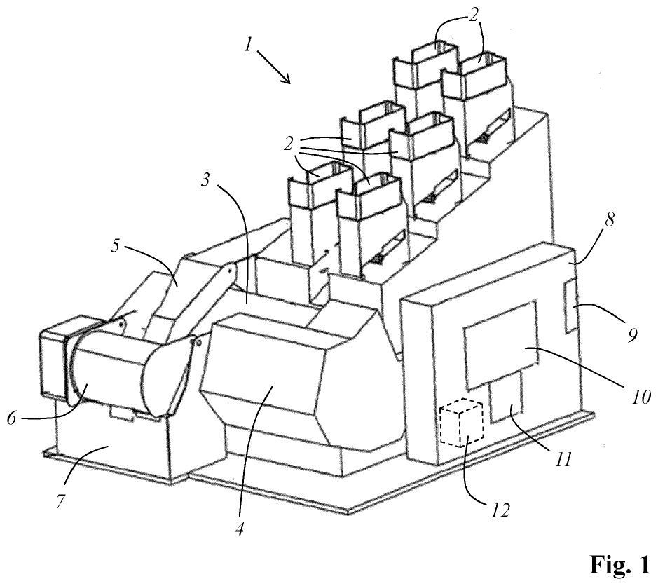

FIG. 1 shows a first exemplary embodiment of a printer according to the invention, which comprises a material supply 1. The material supply 1 contains a plurality of stack magazines 2 for histology-laboratory consumable articles 16 (not visible in this figure) to be printed on, for example cassettes 17 or slides 19 or labels. The material supply 1 is assigned a transport apparatus 3 which respectively transports a histology-laboratory consumable article 16 in succession from the material supply 1 to a printing device 4. The printing device 4 may, for example, contain an inkjet printer. The histology-laboratory consumable articles 16 that have been printed on are conveyed by the transport apparatus 3 to a warm-air drying apparatus 5 and predried there. The histology-laboratory consumable articles 16 are then conveyed to a flash device 6 which ensures full drying of the ink by supplying heat with infrared radiation and/or UV radiation. The histology-laboratory consumable articles 16 processed in this way are subsequently forwarded to a removal device 7.

A control apparatus (8) is configured to receive analog or digital image signals of a target impression image pattern and to correspondingly control the printing device 4 in order to print an impression which is as close as possible to the target impression image pattern onto the histology-laboratory consumable article 16.

The control apparatus 8 comprises an interface 9 for connecting the printer to a computer network or for direct connection to a computer. The control apparatus 8 receives the analog or digital image signals of the target impression image pattern, which can contain in particular patient data in clear text or in coded form, for example from a superordinate computer (not represented in this figure) to which the printer is connected by means of the interface 9.

The printer comprises an optical reading apparatus 13 (not visible in FIG. 1), which reads an impression 18 printed by the printing device 4 onto a histology-laboratory consumable article 16 and generates analog or digital impression image signals relating to the impression 18 that has been read. The impression image signals are transferred to the control apparatus 8 of the printer. The control apparatus 8 evaluates the impression image signals received from the optical reading apparatus (13) by comparing them with the analog or digital image signals of the target impression image pattern and determines at least one quality parameter relating to the impression (18). The quality parameter can be displayed to the user and/or be used to establish a processing step for the further processing of the histology-laboratory consumable article (16) inside the printer.

The control apparatus 8 furthermore comprises a display 10, by means of which messages can be output to a user. In particular, the display 10 may also be used to request inputs by a user, which the user may input via an input apparatus 11, which may for example be a keypad. The display 10 may, for example, also be used to continuously display information about the impressions 18 that have been read by means of the optical reading apparatus and/or the evaluation results relating to the impressions 18 that have been read.

The control apparatus 8 contains a memory apparatus 12 in which the control apparatus respectively saves the received impression image signals respectively together with the image signals of the associated target impression image pattern. In particular, a log, which may be forwarded via the interface 9 to a connected computer and/or which may be represented on the display 10, may advantageously be saved in the memory apparatus 12.

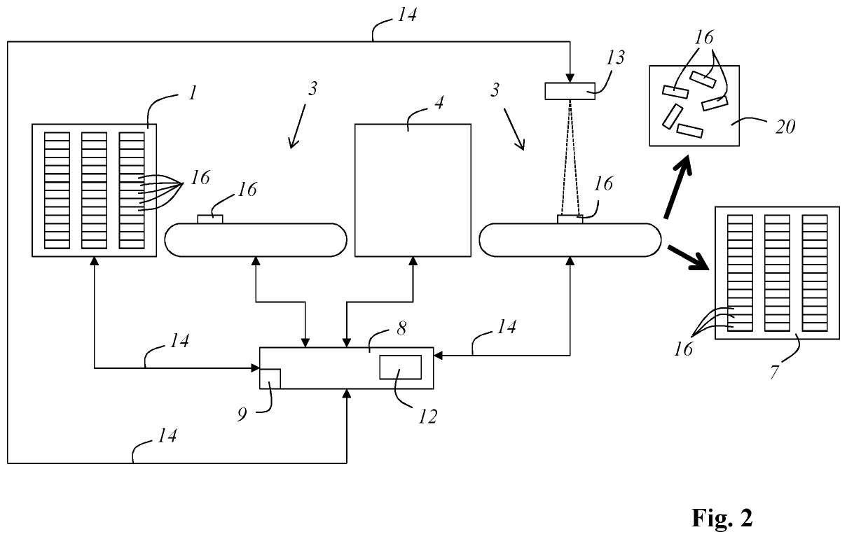

FIG. 2 schematically shows a second exemplary embodiment of a printer according to the invention.

The printer comprises a material supply 1, in which histology-laboratory consumable articles 16 to be printed on, for example cassettes 17 or slides 19, can be stored.

The printer furthermore comprises a transport apparatus 3, which respectively transports a histology-laboratory consumable article 16 in succession from the material supply 1 to a printing device 4. The transport apparatus 3 furthermore transports the histology-laboratory consumable articles 16 that have been printed on by the printing device 4 to a removal device 7, from which the histology-laboratory consumable articles 16 that have been printed on can then be removed.

The printer furthermore comprises an optical reading apparatus 13, which reads an impression 18 printed by the printing device 4 onto a histology-laboratory consumable article 16 while it is being transported away from the printing device 4. The optical reading apparatus 13 generates analog or digital impression image signals relating to the impression 18 that has been read and transfers the impression image signals to the control apparatus 8. The control apparatus 8 comprises an interface 9 for connecting the printer to a computer network or for direct connection to a computer.

The control apparatus 8 is connected by means of data cables 14 to the material supply 1, the transport apparatus 3 and the printing device 4, in order to receive data and/or output control instructions.

The control apparatus 8 evaluates the impression image signals received from the optical reading apparatus 13. This is done by comparing the received impression image signals with the analog or digital image signals of the associated target impression image pattern. The control apparatus 8 of the printer receives the analog or digital image signals of the target impression image pattern, which can contain in particular patient data in clear text or in coded form, from a superordinate computer (not represented in this figure) to which the printer is connected by means of the interface 9. In particular the control apparatus 8 may advantageously control the printing device 4 correspondingly in order respectively to print an impression 18 as similar as possible to the target impression image pattern onto the histology-laboratory consumable article.

If the evaluation reveals that the impression 18 applied onto the respective histology-laboratory consumable article 16 is error-free, the control apparatus 8 controls the transport apparatus 3 in such a way that the histology-laboratory consumable article 16 is transported to the removal device 7.

If the evaluation reveals that the impression 18 applied onto the respective histology-laboratory consumable article 16 is not error-free, the histology-laboratory consumable article 16 is excluded. In this case, the control apparatus 8 controls the transport apparatus 3 in such a way that the histology-laboratory consumable article 16 is transported to a further removal device 20, from which the user can remove the histology-laboratory consumable article 16 that has been incorrectly printed on, in particular for subsequent disposal.

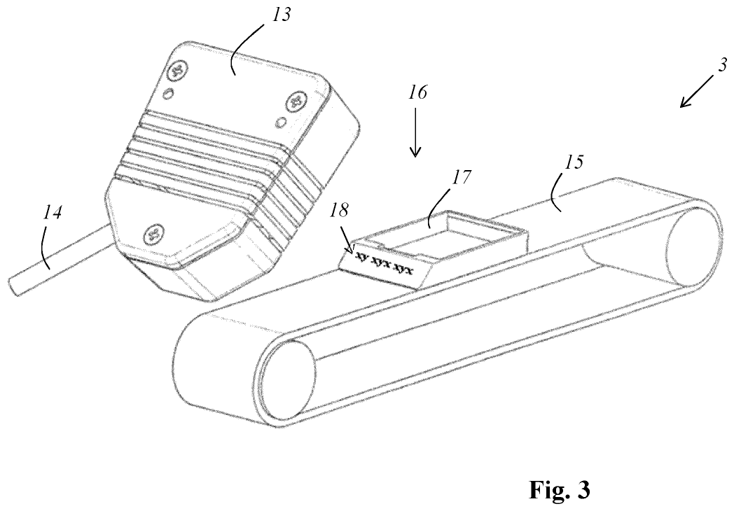

FIG. 3 shows a detail of a third exemplary embodiment of a printer according to the invention, which comprises a transport device 3. The transport device 3 transports further the histology-laboratory consumable articles 16 which have been provided with an impression in a printing device 4 (not represented in this figure). The transport device 3 comprises a conveyor belt 15 on which the histology-laboratory consumable articles 16, namely cassettes 17, are transported.

The printer contains an optical reading apparatus 13, which may for example be configured as a digital camera. The optical reading apparatus 13 is connected via a data cable 14 to a control apparatus 8 (not represented in this figure). The optical reading apparatus 13 reads the impression 18 of each histology-laboratory consumable article 16 passing it and forwards analog or digital impression image signals relating to the impression 18 that has been read via the data cable 14 to the control apparatus 8.

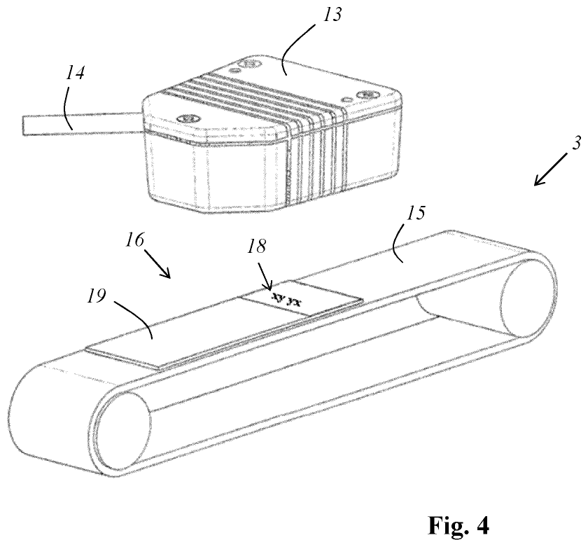

FIG. 4 shows a detail of a third exemplary embodiment of a printer according to the invention, which comprises a transport device 3. The transport device 3 transports further the histology-laboratory consumable articles 16 which have been provided with an impression 18 in a printing device 4 (not represented in this figure). The transport device 3 comprises a conveyor belt 15 on which the histology-laboratory consumable articles 16, slides 19, are transported.

The printer contains an optical reading apparatus 13, which may for example be configured as a digital camera. The optical reading apparatus 13 is connected via a data cable 14 to a control apparatus 8 (not represented in this figure). The optical reading apparatus 13 reads the impression 18 of each histology-laboratory consumable article 16 passing it and forwards analog or digital impression image signals relating to the impression 18 that has been read via the data cable 14 to the control apparatus 8.

### LIST OF REFERENCES

1 material supply
2 stack magazine
3 transport apparatus
4 printing device
5 warm-air drying apparatus
6 flash device
7 removal device
8 control apparatus
9 interface
10 display
11 input apparatus
12 memory apparatus
13 optical reading apparatus
14 data cable
15 conveyor belt
16 histology-laboratory consumable article
17 cassette
18 impression
19 slide
20 further removal device

1. A printer having a printing device (4) for printing on histology-laboratory consumable articles (16) having a control apparatus (8) which is configured to receive analog or digital image signals of a target impression image pattern, and having an optical reading apparatus (13), wherein the optical reading apparatus (13) reads an impression (18) printed on a histology-laboratory consumable article (16) by the printing device (4), generates analog or digital impression image signals relating to the impression (18) that has been read, and transfers the impression image signals to the control apparatus (8), which evaluates the impression image signals received from the optical reading apparatus (13) by comparing them with the analog or digital image signals of the target impression image pattern and determines at least one quality parameter relating to the impression (18).

2. The printer as claimed in claim 1, wherein the control apparatus (8) as a function of the evaluation result establishes at least one processing step for the further processing of the histology-laboratory consumable article (16) inside the printer.

3. The printer as claimed in claim 1, wherein the control apparatus (8) compares the impression image signals received from the optical reading apparatus (13) with the image signals of the target impression image pattern by image analysis and/or pattern recognition.

4. The printer as claimed in claim 1, wherein:
a. the quality parameter relates to the sharpness of the impression (18), and/or
b. the quality parameter relates to the contrast of the impression (18), and/or in that
c. the quality parameter relates to the printing resolution of the impression (18), and/or
d. the quality parameter relates to the accuracy of the color of the impression (18), and/or
e. the quality parameter relates to the constancy of the color of the impression (18), and/or
f. the quality parameter relates to the color gradient of the impression (18), and/or
g. the quality parameter relates to the location of the impression (18) on the histology-laboratory consumable article (16), and/or
h. the quality parameter relates to the presence of the impression (18) on the histology-laboratory consumable article (16).

5. The printer as claimed in claim 1, wherein one of the processing steps involves requesting an input by a user.

6. The printer as claimed in claim 5, wherein the control apparatus (8) evaluates the input, and as a function of the input, deletes an already established processing step and/or establishes at least one further processing step for the further processing of the histology-laboratory consumable article (16).

7. The printer as claimed in claim 5, wherein the control apparatus (8) stops the processing of a histology-laboratory consumable article (16), in relation to which an input is expected, until the input arrives, and instead begins or continues the processing of at least one other histology-laboratory consumable article (16).

8. The printer as claimed in claim 2, wherein one of the processing steps involves outputting a message to a user.

9. The printer as claimed in claim 2, wherein one of the processing steps involves repeating the printing of the target impression image pattern on another histology-laboratory consumable article (16).

10. The printer as claimed in claim 9, wherein the control apparatus (8) establishes at least one printing parameter for the repetition of the printing of the target impression image pattern on another histology-laboratory consumable article (16) as a function of the image signals of the impression (18) that has been read and/or as a function of a quality parameter determined relating to the impression (18).

11. The printer as claimed in claim 10, wherein the printing parameter relates to the ink or the toner or a drying temperature or a drying duration or a font size to be used or a font type to be used.

12. The printer as claimed in claim 1, wherein the control apparatus (8) respectively saves the received impression image signals in a memory apparatus (12) or in that the control apparatus (8) respectively saves the received impression image signals together with the image signals of the associated target impression image pattern.

13. The printer as claimed in claim 1, wherein the printer comprises a transport apparatus (3) which transports the histology-laboratory consumable articles (16).

14. The printer as claimed in claim 13, wherein the printer comprises a compartment for a multiplicity of histology-laboratory consumable articles (16) to be printed on, from which the transport apparatus (3) individually takes the histology-laboratory consumable articles (16) to be printed on and transports them further to the printing device (4).

15. The printer as claimed in claim 14, wherein the transport apparatus (3) transports the histology-laboratory consumable articles (16) printed on by the printing device (4) further, in particular to a removal device (7).

16. The printer as claimed in claim 15, wherein the optical reading apparatus (13) reads the impression (18) respectively during the transport of the histology-laboratory consumable article (16) that has been printed on.

17. The printer as claimed in claim 1, wherein:
a. the printing device (4) is configured to apply an impression (18) configured as an image or as a barcode or as a QR code or as a logo or as text onto the histology-laboratory consumable article, and/or
b. the optical reading apparatus (13) is configured and arranged to read an impression (18) configured as an image or as a barcode or as a QR code or as a logo or as text.

18. The printer as claimed in claim 1, wherein the control apparatus (8) continuously keeps a log.

19. The printer as claimed in claim 18, wherein the control apparatus (8) saves log data in a memory and/or outputs them via an interface and/or displays them on an output device.

20. The printer as claimed in claim 1, wherein the printer is configured as an inkjet printer or as a laser printer.

21. The printer as claimed in claim 1, wherein the printer is configured as a cassette printer and/or as a slide printer and/or as a label printer.

22. The printer as claimed in claim 1, wherein the histology-laboratory consumable article (16) is a cassette (17) or a slide (19) or a label.

23. A histology laboratory system which comprises a printer as claimed in claim 1 and a superordinate computer, which receives log data from the printer.

24. The histology laboratory system as claimed in claim 23, wherein:
a. the superordinate computer receives further log data of other printers and/or other laboratory equipment, or in that
b. the superordinate computer receives further log data of other printers and/or other laboratory equipment and respectively saves and/or further processes the log data and the further log data, which relate to the same sample, while being assigned to one another and together.
